(19) United States
(12) Patent Application Publication
(10) Pub. No.: US 2025/0208322 A1
(43) Pub. Date: Jun. 26, 2025

(54) IMAGING DEVICE AND THREE-DIMENSIONAL MEASUREMENT DEVICE INCLUDING SAME

(71) Applicant: Panasonic Intellectual Property Management Co., Ltd., Osaka (JP)

(72) Inventors: Toru OKINO, Osaka (JP); Shigeru SAITOU, Kyoto (JP); Yusuke YUASA, Osaka (JP); Shinzo KOYAMA, Osaka (JP)

(21) Appl. No.: 18/852,155

(22) PCT Filed: Mar. 24, 2023
(86) PCT No.: PCT/JP2023/011883

§ 371 Date: Sep. 27, 2024

(30) Foreign Application Priority Data
Mar. 30, 2022 (JP) 2022-057129

(51) Int. Cl. G02B 5/00; G01C 3/24; G06T 7/55; H04N 23/55

(52) U.S. Cl. CPC G02B 5/005; G01C 3/24; G06T 7/55; H04N 23/55

(57) ABSTRACT

An imaging device includes a first imaging lens configured to allow light from a subject to pass; a first solid-state image sensing element configured to receive light having passed through the first imaging lens; a second imaging lens spaced apart from the first imaging lens in the first direction; a second lens-side shielding part which includes a primary second lens-side light transmitting part and a secondary second lens-side light transmitting part formed in different positions in a second direction perpendicular to the first direction, and which is configured to allow part of light from the subject toward the second imaging lens to pass using the primary second lens-side light transmitting part and the secondary second lens-side light transmitting part while blocking the rest of the light; and a second solid-state image sensing element configured to receive light from the subject having passed through the second imaging lens.

### TECHNICAL FIELD

The present disclosure relates to an imaging device and a three-dimensional measurement device including the same.

### BACKGROUND ART

Patent Document 1 discloses a three-dimensional measurement device including a first imaging unit configured to obtain a first image, a second imaging unit configured to obtain a second image, and a third imaging unit configured to obtain a third image, which are spaced apart from one another and arranged in a triangular shape. This three-dimensional measurement device determines, for at least one pixel of the first image, a first similarity value related to a pixel of the second image along a first epipolar line; determines, for the at least one pixel of the first image, a second similarity value related to a pixel of the third image along a second epipolar line; combines the first similarity value and the second similarity values; determines, for the at least one pixel, a common parallax among the first image, the second image, and the third image; and determines a distance from the common parallax.

### CITATION LIST

### Patent Document

[Patent Document 1] U.S. Pat. No. 11,039,114

### SUMMARY OF THE INVENTION

### Technical Problem

However, in Patent Document 1, the first to third imaging units are each required to have a solid-state image sensing element, and this leads to increases in size and cost of the three-dimensional measurement device.

In view of the foregoing, it is an object of the present disclosure to achieve downsizing and cost reduction of a three-dimensional measurement device.

### Solution to the Problem

To achieve the object, an imaging device of the present disclosure includes: a first imaging lens configured to allow light from a subject to pass; a first solid-state image sensing element configured to receive light having passed through the first imaging lens; a second imaging lens spaced apart from the first imaging lens in a first direction and configured to allow light from the subject to pass; a second lens-side shielding part which includes a primary second lens-side light transmitting part and a secondary second lens-side light transmitting part formed in different positions in a second direction perpendicular to the first direction, and which is configured to allow part of light from the subject toward the second imaging lens to pass using the primary second lens-side light transmitting part and the secondary second lens-side light transmitting part while blocking the rest of the light; and a second solid-state image sensing element configured to receive light from the subject having passed through the second imaging lens.

Thus, the first image based on the light from the subject having passed through the first imaging lens can be obtained based on an output from the first solid-state image sensing element, and the second image based on the light from the subject having passed through the primary second lens-side light transmitting part and the third image based on the light from the subject having passed through the secondary second lens-side light transmitting part can be obtained based on an output from the second solid-state image sensing element. Therefore, it is unnecessary to provide three solid-state image sensing elements in order to obtain the first image, the second image, and the third image captured from three points forming a triangular shape, and thus the three-dimensional measurement device can be downsized and its cost can be reduced.

### Advantages of the Invention

The present disclosure enables downsizing and cost reduction of a three-dimensional measurement device.

### BRIEF DESCRIPTION OF THE DRAWINGS

FIG. 1 is a block diagram showing a configuration of a three-dimensional measurement device of a first embodiment.

FIG. 2 is a front view of an imaging device.

FIG. 3 is a cross-sectional view taken along line III-III in FIG. 2.

FIG. 4 is a cross-sectional view taken along line IV-IV in FIG. 2.

FIG. 5 is a plan view showing part of a sub-lens array.

FIG. 6 is an explanatory diagram showing how a corresponding block in a second image is searched for if a first epipolar line is a straight line of y=x.

FIG. 7 is an explanatory diagram showing how a corresponding block in a second image is searched for if a first epipolar line is a straight line of y=x/2.

FIG. 8 is a graph illustrating a relationship between a luminance value output from a solid-state image sensing element in a uniform light irradiation state and a position of the solid-state image sensing element in an up-down direction.

FIG. 9 is a flowchart explaining a distance information generation process by the three-dimensional measurement device of the first embodiment.

FIG. 10 is a flowchart explaining a parallax information obtaining process.

FIG. 11 is a flowchart explaining a parallax calculation process.

FIG. 12 shows a second embodiment and corresponds to FIG. 1.

FIG. 13 shows a third embodiment and corresponds to FIG. 1.

FIG. 14 shows that a first lens-side light transmitting part is moved upward and corresponds to FIG. 2.

FIG. 15 is an explanatory diagram explaining a rotation movement of a first lens-side shielding part.

### DESCRIPTION OF EMBODIMENTS

Embodiments of the present disclosure will be described below with reference to the drawings.

### First Embodiment

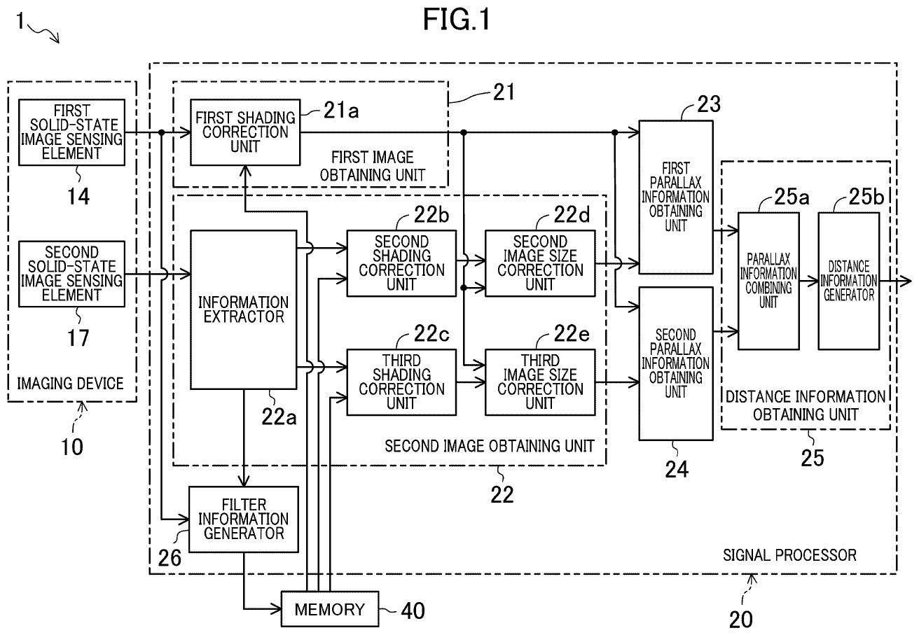

FIG. 1 shows a three-dimensional measurement device 1 of a first embodiment of the present disclosure. The three-dimensional measurement device 1 includes an imaging device 10, a signal processor 20, and a memory 40.

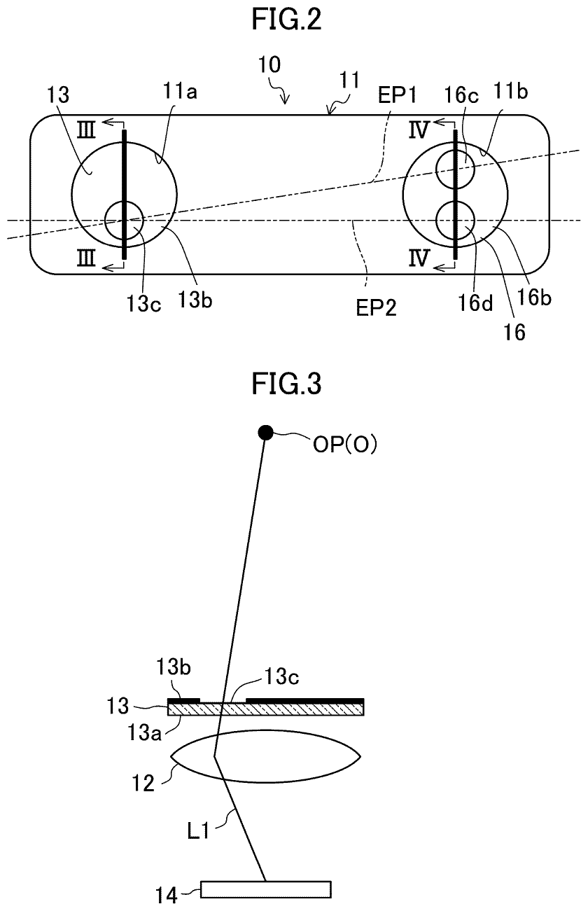

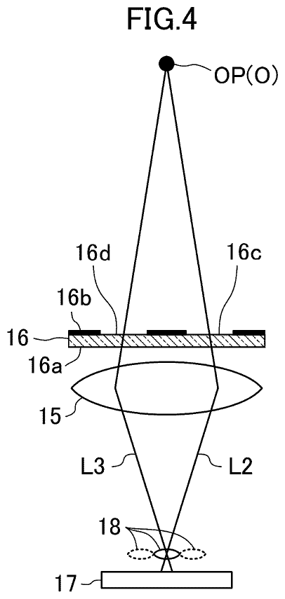

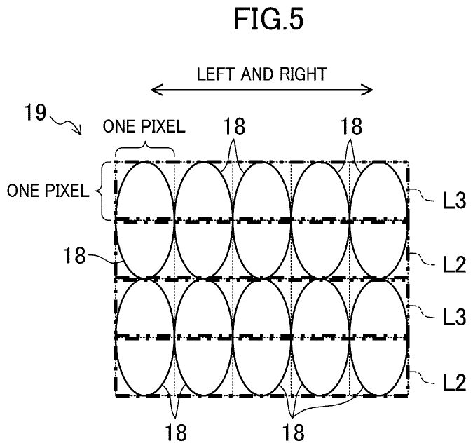

As shown in FIGS. 2 to 4, the imaging device 10 includes a housing 11, a first imaging lens 12, a first lens-side shielding part 13, a first solid-state image sensing element 14, a second imaging lens 15, a second lens-side shielding part 16, a second solid-state image sensing element 17, a sub-lens array 19 including a plurality of sub-lenses 18 (see FIG. 5). In FIGS. 3 and 4, a point OP indicates a point contained in a subject O.

In the housing 11, a first opening 11a and a second opening 11b that have a perfect circular shape and are open in the same direction are spaced apart from each other in a horizontal direction as a first direction and pass through in another horizontal direction perpendicular to the first direction. The shape of the housing 11 is not limited to that shown in FIG. 2. The housing 11 accommodates a first imaging lens 12, a first lens-side shielding part 13, a first solid-state image sensing element 14, a second imaging lens 15, a second lens-side shielding part 16, a second solid-state image sensing element 17, and a sub-lens array 19.

The first imaging lens 12 is arranged so as to face the first opening 11a of the housing 11. The first imaging lens 12 allows light from the subject O to pass.

The first lens-side shielding part 13 has a plate shape and is arranged between a surface of the housing 11 where the first opening 11a is formed and the first imaging lens 12 so as to face the first opening 11a of the housing 11. The first lens-side shielding part 13 has a glass plate 13a arranged to face the first opening 11a of the housing 11. In a region excluding a perfect circular region in the lower half portion of the surface of the glass plate 13a facing the first opening 11a, a coating film 13b is formed by paint application over the entire region. The region of the glass plate 13a where the coating film 13b is not formed constitutes the first lens-side light transmitting part 13c having a perfect circular shape and allowing light to pass. The first lens-side shielding part 13 allows part of light from the subject O toward the first imaging lens 12 to pass using the first lens-side light transmitting part 13c, while blocking the rest of the light. The glass plate 13a may be replaced with a translucent plate made of a material such as resin other than glass. The coating film 13b may be replaced with a light shielding layer made of a material other than a coating paint.

The first solid-state image sensing element 14 receives light L1 from the subject O having passed through the first lens-side light transmitting part 13c of the first lens-side shielding part 13 and the first imaging lens 12, and outputs luminance values for a plurality of pixels.

The second imaging lens 15 is spaced apart from the first imaging lens 12 in the first direction, and arranged to face the second opening 11b of the housing 11. That is, the thickness direction of the second imaging lens 15 is oriented in the same direction as that of the first imaging lens 12. The second imaging lens 15 also allows light from the subject O to pass.

The second lens-side shielding part 16 has a plate shape and is arranged between a surface of the housing 11 where the second opening 11b is formed and the second imaging lens 15 so as to face the second opening 11b of the housing 11. The second lens-side shielding part 16 has a glass plate 16a arranged to face the second opening 11b of the housing 11. In a region excluding a perfect circular region in the upper half portion and a perfect circular region in the lower half portion of the surface of the glass plate 16a facing the second opening 11b, a coating film 16b is formed by paint application over the entire region. The upper region of the glass plate 16a where the coating film 16b is not formed constitutes the primary second lens-side light transmitting part 16c having a perfect circular shape and allowing light to pass. The lower region of the glass plate 16a where the coating film 16b is not formed constitutes the secondary second lens-side light transmitting part 16d having a perfect circular shape and allowing light to pass. The second lens-side shielding part 16 allows part of light from the subject O toward the second imaging lens 15 to pass using the primary second lens-side light transmitting part 16c and the secondary second lens-side light transmitting part 16d, while blocking the rest of the light. The secondary second lens-side light transmitting part 16d is positioned at the same level in the up-down direction as the first lens-side light transmitting part 13c. A spacing in the up-down direction between the primary second lens-side light transmitting part 16c and the secondary second lens-side light transmitting part 16d is set longer than 0 and shorter than the diameter of the second imaging lens 15. Since the primary second lens-side light transmitting part 16c and the secondary second lens-side light transmitting part 16d are formed in different positions relative to the up-down direction (a second direction perpendicular to the first direction), the first lens-side light transmitting part 13c, the primary second lens-side light transmitting part 16c, and the secondary second lens-side light transmitting part 16d can form two epipolar lines EP1 and EP2 having different inclinations. The positional relationship among the first lens-side light transmitting part 13c, the primary second lens-side light transmitting part 16c, and the secondary second lens-side light transmitting part 16d may be varied as long as the centers of gravity thereof do not align along a straight line in the horizontal direction and two epipolar lines EP1 and EP2 having different inclinations can be formed. The epipolar lines EP1 and EP2 will be described in detail later.

The second solid-state image sensing element 17 receives light L2 and light L3 from the subject O having passed through the primary second lens-side light transmitting part 16c and the secondary second lens-side light transmitting part 16d of the second lens-side shielding part 16 and the second imaging lens 15.

The sub-lenses 18 constituting the sub-lens array 19 are interposed between the second imaging lens 15 and the second solid-state image sensing element 17 and in parallel with the second imaging lens 15. The sub-lenses 18 are positioned at the focal point of the second imaging lens 15 opposite to the second lens-side shielding part 16. As shown in FIG. 5, the sub-lens 18 has an elliptical shape of which the length in the up-down direction (hereinafter referred to as “second direction”) is approximately twice the length in the first direction. The length and position of each sub-lens 18 in the first direction are set so that an irradiated region in the second solid-state image sensing element 17 which is irradiated with the light L2 having passed through the sub-lenses 18 is set within one pixel of the second solid-state image sensing element 17 in the first direction. The light L2 having passed through the primary second lens-side light transmitting part 16c passes through the lower half (one of the halves in the second direction) of the sub-lens 18, and the light L3 having passed through the secondary second lens-side light transmitting part 16d passes through the upper half (the other one of the halves in the second direction) of the sub-lens 18. The light L2 and light L3 having passed through the sub-lens 18 are incident on their respective regions of the second solid-state image sensing element 17 corresponding to mutually different pixels. The length and position of each sub-lens 18 in the second direction are set so that an irradiated region in the second solid-state image sensing element 17 which is irradiated with the light L2 and light L3 having passed through the sub-lenses 18 is set within two pixels of the second solid-state image sensing element 17 in the second direction. The plurality of sub-lenses 18 are provided so as to be adjacent to one another in the first direction. The number of sub-lenses 18 in the first direction corresponds to the number of pixels aligned in the first direction in the second solid-state image sensing element 17.

The signal processor 20 includes a first image obtaining unit 21, a second image obtaining unit 22, a first parallax information obtaining unit 23, a second parallax information obtaining unit 24, a distance information obtaining unit 25, and a filter information generator 26.

The first image obtaining unit 21 obtains a first image based on the luminance values of a plurality of pixels output from the first solid-state image sensing element 14. The first image obtaining unit 21 has a first shading correction unit 21a. The first shading correction unit 21a obtains the first image by correcting, according to positions in the second direction, the luminance values of the plurality of pixels output from the first solid-state image sensing element 14. Specifically, the correction multiplies the luminance values of all the pixels output from the first solid-state image sensing element 14 by a first correction value obtained for each position in the second direction through a later-described calibration process and stored in the memory 40. Then, the first image obtaining unit 21 outputs corrected luminance values of all the pixels output from the first solid-state image sensing element 14 as the luminance values of all the pixels of the first image.

Based on the luminance values of the plurality of pixels output from the second solid-state image sensing element 17, the second image obtaining unit 22 obtains a second image based on the light L2 having passed through the primary second lens-side light transmitting part 16c and a third image based on the light L3 having passed through the secondary second lens-side light transmitting part 16d. Specifically, the second image obtaining unit 22 includes an information extractor 22a, a second shading correction unit 22b, a third shading correction unit 22c, a second image size correction unit 22d, and a third image size correction unit 22e.

From the luminance values of all the pixels output from the second solid-state image sensing element 17, the information extractor 22a extracts luminance values of pixels based on the light L2 having passed through the primary second lens-side light transmitting part 16c and luminance values of pixels based on the light L3 having passed through the secondary second lens-side light transmitting part 16d.

The second shading correction unit 22b obtains a first pre-size correction image by correcting, according to positions in the second direction, the luminance values of pixels extracted by the information extractor 22a and based on the light L2 having passed through the primary second lens-side light transmitting part 16c. Specifically, the second shading correction unit 22b performs correction that multiplies the luminance values of all the pixels based on the light L2 having passed through the primary second lens-side light transmitting part 16c by a second correction value obtained for each position in the second direction through a later-described calibration process and stored in the memory 40.

The third shading correction unit 22c obtains a second pre-size correction image by correcting, according to positions in the second direction, the luminance values of pixels extracted by the information extractor 22a and based on the light L3 having passed through the secondary second lens-side light transmitting part 16d. Specifically, the third shading correction unit 22c performs correction that multiplies the luminance values of all the pixels based on the light L3 having passed through the secondary second lens-side light transmitting part 16d by a third correction value obtained for each position in the second direction through a later-described calibration process and stored in the memory 40.

The second image size correction unit 22d corrects the image size of the first pre-size correction image obtained by the second shading correction unit 22b and outputs a corrected image as the second image. Based on the information of the first image output from the first shading correction unit 21a, the second image size correction unit 22d corrects the image size so that the second image has the same size (the same pixel count) as that of the first image. At this time, the second image is stretched in the up-down direction but not in the left-right direction. Therefore, the accuracy in the search on the first epipolar line EP1 described later is not lowered.

The third image size correction unit 22e corrects the image size of the second pre-size correction image obtained by the third shading correction unit 22c and outputs a corrected image as the third image. Based on the information of the first image output from the first shading correction unit 21a, the third image size correction unit 22e corrects the image size so that the third image has the same size (the same pixel count) as that of the first image. At this time, the third image is stretched in the up-down direction but not in the left-right direction. Therefore, the accuracy in the search on the second epipolar line EP2 described later is not lowered.

Regarding a plurality of component blocks (component parts) constituting the first image, the first parallax information obtaining unit 23 searches for corresponding blocks (corresponding parts) corresponding to their respective component blocks on the first epipolar line EP1 of the second image. Then, the first parallax information obtaining unit 23 obtains first parallax information indicating distances (distances in the direction along the first epipolar line EP1) between the positions of the plurality of component blocks in the first image and the positions of their respective corresponding blocks in the second image. The first epipolar line EP1 used for the search here is a line of intersection between an epipolar plane and the second image, where the epipolar plane connects a point OP of the subject O, the first lens-side light transmitting part 13c of the first lens-side shielding part 13, and the primary second lens-side light transmitting part 16c of the second lens-side shielding part 16. The first parallax information is image information indicating a parallax image where the pixel value of each component block in the first image is converted according to the distance between the position of the component block in the first image and the position of the corresponding block in the second image. In this image information, the pixel value of a component block whose corresponding block (corresponding part) has not been detected on the first epipolar line EP1 of the second image is set to a predetermined blank value indicating a blank.

The first epipolar line EP1 is inclined in the up-down direction with respect to a lateral direction in the second image.

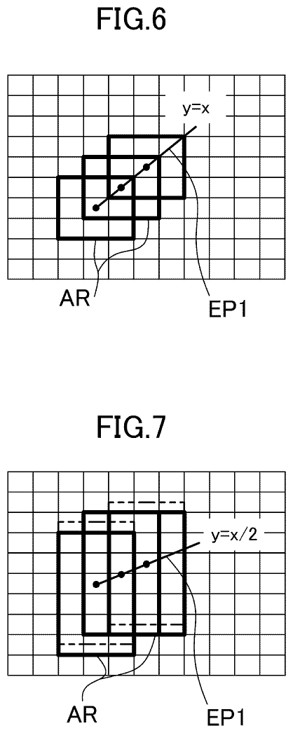

As shown in FIG. 6, when, for example, in the second image, the lateral direction is an x-axis, the longitudinal direction is a y-axis, and the first epipolar line EP1 is a straight line of y=x, a corresponding block corresponding to its respective component block (each component block is a square formed by three pixels laterally and three pixels longitudinally) constituting the first image is searched for on the first epipolar line EP1 of the second image.

As shown in FIG. 7, when, for example, in the second image, the lateral direction is an x-axis, the longitudinal direction is a y-axis, and the first epipolar line EP1 is a straight line of y=x/2, a corresponding block corresponding to its respective component block (each component block is a rectangle formed by three pixels laterally and six pixels longitudinally) constituting the first image is searched for on the first epipolar line EP1 of the second image.

That is, when, in the second image, the lateral direction is an x-axis, the longitudinal direction is a y-axis, and the first epipolar line EP1 is a straight line of y=ax+b, the component block and the corresponding block each contains pixels, where the number of pixels in the longitudinal direction is 1/a times the number of pixels in the lateral direction.

Regarding a plurality of component blocks constituting the first image, the second parallax information obtaining unit 24 searches for corresponding blocks corresponding to their respective component blocks on the second epipolar line EP2 of the third image. Then, the second parallax information obtaining unit 24 obtains second parallax information indicating distances between the positions of the plurality of component blocks in the first image and the positions of their respective corresponding blocks in the third image. The second epipolar line EP2 used for the search here is a line of intersection between an epipolar plane and the third image, where the epipolar plane connects the point of the subject O, the first lens-side light transmitting part 13c of the first lens-side shielding part 13, and the secondary second lens-side light transmitting part 16d of the second lens-side shielding part 16. The second epipolar line EP2 extends in a lateral direction of the third image, and is not inclined in the up-down direction with respect to the lateral direction of the third image. The second parallax information is image information indicating a parallax image where the pixel value of each component block in the first image is converted according to the distance between the position of the component block of the first image and the position of the corresponding block in the third image. In this image information, the pixel value of a component block whose corresponding block (corresponding part) has not been detected on the second epipolar line EP2 of the third image is set to a predetermined blank value indicating a blank.

The distance information obtaining unit 25 obtains distance information based on the first parallax information obtained by the first parallax information obtaining unit 23 and the second parallax information obtained by the second parallax information obtaining unit 24. The distance information is information indicating the distance between the imaging device 10 and the subject O captured in each component block constituting the first image. Specifically, the distance information is image information indicating an image where the pixel value of each component block in the first image is adjusted according to the distance between the imaging device 10 and the subject O captured in that component block.

The distance information obtaining unit 25 includes a parallax information combining unit 25a and a distance information generator 25b.

The parallax information combining unit 25a obtains combined parallax information by replacing a pixel value of each pixel having a blank value in the image indicated by the first parallax information with a pixel value of the corresponding pixel in the image indicated by the second parallax information. That is, the combined parallax information is image information obtained by compensating the first parallax information with the second parallax information.

The distance information generator 25b generates the distance information based on the combined parallax information obtained by the parallax information combining unit 25a.

When the distance between the subject O captured in a component block and the imaging device 10 (distance indicated by the pixel value of each pixel in the distance information) is z, the parallax indicated by the combined parallax information is d, an interval in the first direction between the first lens-side light transmitting part 13c and the primary and secondary second lens-side light transmitting parts 16c and 16d is b, and the focal length is f, the distance z is calculated by the following general Formula 1.

$$z = b \cdot f / d \qquad ( Formula 1 )$$

The filter information generator 26 obtains the luminance value output from the first solid-state image sensing element 14 and the second solid-state image sensing element 17 at the time of shipment, and performs a calibration process including calculating a first correction value, a second correction value, and a third correction value based on the luminance value and storing them in the memory 40. The filter information generator 26 obtains the luminance value in a uniform light irradiation state where uniform light is emitted to the first lens-side light transmitting part 13c of the first lens-side shielding part 13 and to the primary second lens-side light transmitting part 16c and the secondary second lens-side light transmitting part 16d of the second lens-side shielding part 16 from the side where the first opening 11a or second opening 11b is located. That is, in the uniform light irradiation state, the intensity of incident light is uniform throughout all the positions on the surfaces of the first lens-side light transmitting part 13c, the primary second lens-side light transmitting part 16c, and the secondary second lens-side light transmitting part 16d.

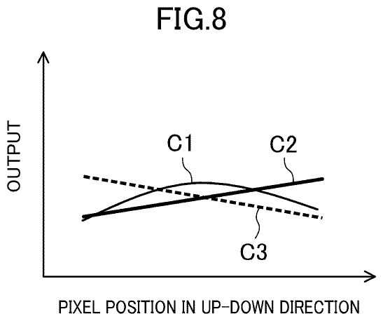

FIG. 8 shows an exemplary relationship between the luminance value output from the first solid-state image sensing element 14 and the second solid-state image sensing element 17 in the uniform light irradiation state and the positions in the solid-state image sensing elements 14 and 17 in the up-down direction, where the first lens-side light transmitting part 13c is arranged to face the center of the first imaging lens 12. In FIG. 8, the right side in the x-axis direction indicates the upper side.

When the first lens-side light transmitting part 13c is arranged to face the center of the first imaging lens 12, the luminance value of an irradiated region in the first solid-state image sensing element 14 which is irradiated with the light L1 having passed through the first lens-side light transmitting part 13c is larger in the middle of the second direction (up-down direction) in the irradiated region as shown by a curve C1 in FIG. 8. The luminance value of an irradiated region in the second solid-state image sensing element 17 which is irradiated with the light L2 having passed through the primary second lens-side light transmitting part 16c is larger on the upper side in the irradiated region as shown by a curve C2 in FIG. 8. The luminance value of an irradiated region in the second solid-state image sensing element 17 which is irradiated with the light L3 having passed through the secondary second lens-side light transmitting part 16d is larger on the lower side in the irradiated region as shown by a curve C3 in FIG. 8.

The filter information generator 26 calculates, as a first correction value for each pixel, a reciprocal of the luminance value of the irradiated region of the light L1 having passed through the first lens-side light transmitting part 13c in the uniform light irradiation state. At this time, the first correction values for the pixels at the same position in the second direction are the same.

The filter information generator 26 calculates, as a second correction value for each pixel, a reciprocal of the luminance value of the irradiated region of the light L2 having passed through the primary second lens-side light transmitting part 16c in the uniform light irradiation state. Therefore, the second correction value for each pixel is the reciprocal of the value indicated by the curve C2 in FIG. 8. The second correction values for the pixels at the same position in the second direction are the same.

The filter information generator 26 calculates, as a third correction value for each pixel, a reciprocal of the luminance value of the irradiated region of the light L3 having passed through the secondary second lens-side light transmitting part 16d in the uniform light irradiation state. Therefore, the third correction value for each pixel is the reciprocal of the value indicated by the curve C3 in FIG. 8. The third correction values for the pixels at the same position in the second direction are the same.

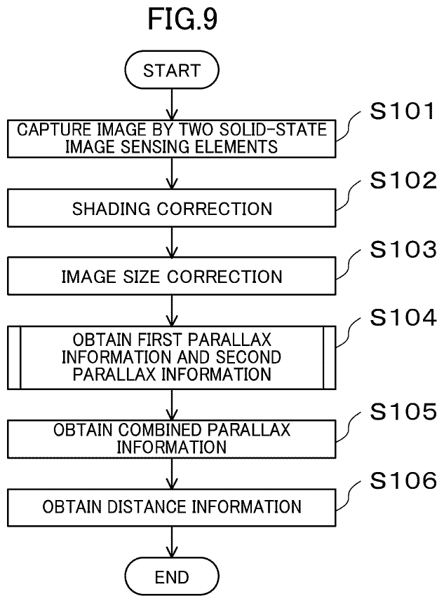

Next, a process of generating the distance information by the three-dimensional measurement device 1 configured as described above will be described with reference to the flowchart of FIG. 9.

First, in (S101), the first solid-state image sensing element 14 and the second solid-state image sensing element 17 receive the light L1, the light L2, and the light L3 from the subject O at the same timing. The light L1 from the subject O is incident on the first solid-state image sensing element 14, where the light L1 has passed through the first lens-side light transmitting part 13c of the first lens-side shielding part 13 and the first imaging lens 12. The light L2 and light L3 from the subject O are incident on the second solid-state image sensing element 17, where the light L2 has passed through the primary second lens-side light transmitting part 16c of the second lens-side shielding part 16, the second imaging lens 15, and the sub-lens 18; and the light L3 has passed through the secondary second lens-side light transmitting part 16d of the second lens-side shielding part 16, the second imaging lens 15, and the sub-lens 18.

Next, in (S102), the first shading correction unit 21a obtains the first image by, based on the first correction value stored in the memory 40, correcting the luminance values of all the pixels output from the first solid-state image sensing element 14 in (S101). From the luminance values of all the pixels output from the second solid-state image sensing element 17 in (S101), the information extractor 22a extracts luminance values of pixels based on the light L2 having passed through the primary second lens-side light transmitting part 16c and luminance values of pixels based on the light L3 having passed through the secondary second lens-side light transmitting part 16d. Then, the second shading correction unit 22b obtains the first pre-size correction image by performing correction based on the second correction value stored in the memory 40 to the luminance values of all the pixels based on the light L2 having passed through the primary second lens-side light transmitting part 16c. The third shading correction unit 22c obtains the second pre-size correction image by, based on the third correction value stored in the memory 40, correcting the luminance values of all the pixels based on the light L3 having passed through the secondary second lens-side light transmitting part 16d.

Next, in (S103), the second image size correction unit 22d corrects the image size of the first pre-size correction image obtained in (S102) and outputs the corrected image as the second image. The third image size correction unit 22e corrects the image size of the second pre-size correction image obtained in (S102) and outputs the corrected image as the third image.

Next, in (S104), the first parallax information obtaining unit 23 obtains the first parallax information based on the first image obtained in (S102) and the second image obtained in (S103). The second parallax information obtaining unit 24 obtains the second parallax information based on the first image obtained in (S102) and the third image obtained in (S103). A method of obtaining the first parallax information and the second parallax information will be described in detail later.

Next, in (S105), the parallax information combining unit 25a of the distance information obtaining unit 25 obtains the combined parallax information based on the first parallax information and the second parallax information obtained in (S104).

Finally, in (S106), the distance information generator 25b of the distance information obtaining unit 25 generates distance information based on the combined parallax information obtained in (S105). Accordingly, a process of generating the distance information by the signal processor 20 is completed.

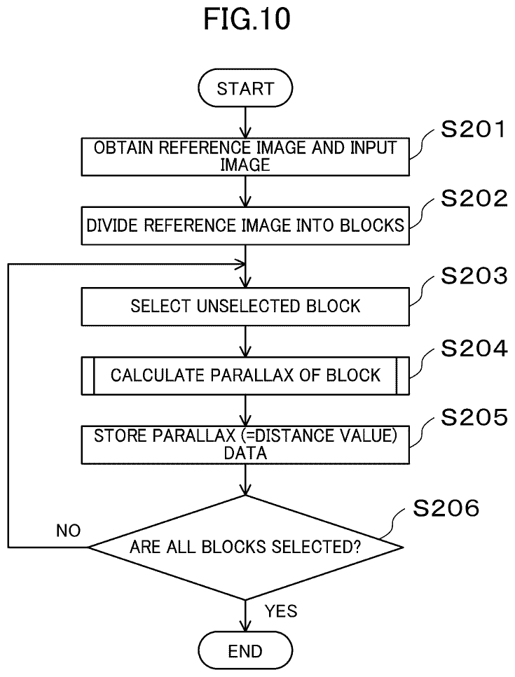

Next, the process of obtaining the first parallax information in (S104) will be described in detail below with reference to the flowchart of FIG. 10. Here, the first image obtained in (S102) is regarded as a reference image, and the second image obtained in (S103) is regarded as an input image.

First, in (S201), the first parallax information obtaining unit 23 obtains the reference image and the input image.

Next, in (S202), the first parallax information obtaining unit 23 divides the reference image into a plurality of component blocks. At this time, when the inclination of the first epipolar line EP1 is a, for example, the number of pixels of the component block in the lateral direction is set to three pixels, and the number of pixels of the component block in the longitudinal direction is set to 1/a times the three pixels.

Next, in (S203), the first parallax information obtaining unit 23 selects an unselected component block from the plurality of component blocks specified by the division in (S202).

Next, in (S204), the first parallax information obtaining unit 23 searches for a corresponding block corresponding to the component block selected in (S203) on the first epipolar line EP1 of the input image, thereby calculating a parallax that is a distance between the position of the component block in the reference image and the position of the corresponding block in the input image. The process in (S204) will be described in detail later.

Next, in (S205), the first parallax information obtaining unit 23 stores a pixel value according to the parallax calculated in (S204) in a parallax image memory (not shown). A storage region for the pixel value in the parallax image memory is a region allocated for the component block selected in (S203).

Next, in (S206), the first parallax information obtaining unit 23 determines whether all the plurality of component blocks specified by the division in (S202) have been selected in (S203). That is, whether or not there still remains an unselected component block is determined. If all the plurality of component blocks specified by division in (S202) have been selected in (S203) and no unselected component block remains, the process of obtaining the first parallax information is ended. On the other hand, if part of the plurality of component blocks specified by the division in (S202) has not been selected in (S203) and there still remains an unselected component block, the process returns to (S203).

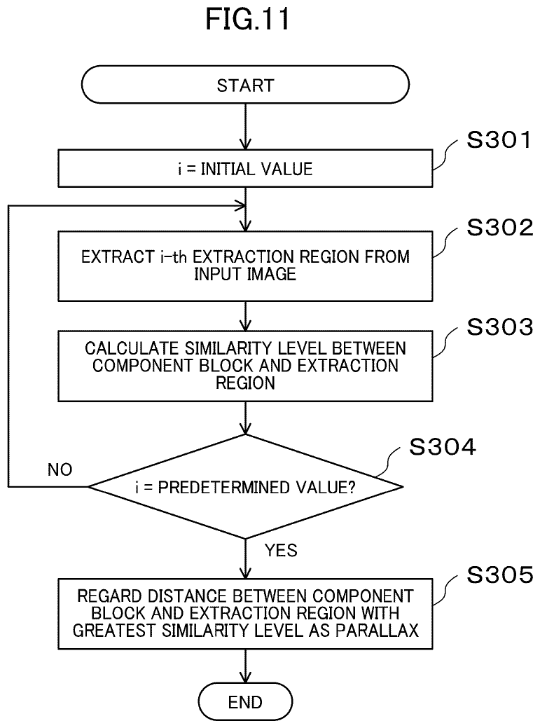

Next, a process of calculating the parallax in (S204) will be described in detail with reference to the flowchart of FIG. 11.

First, in (S301), the first parallax information obtaining unit 23 sets i to an initial value. As the initial value, for example, 1 is set.

Next, in (S302), the first parallax information obtaining unit 23 extracts an extraction region AR (see FIG. 6 and FIG. 7) having the same size as that of the component block selected in (S203). Here, the extraction region AR is moved so that the middle point in the longitudinal direction is positioned on the first epipolar line EP1 extending from the component block selected in (S203) and the middle point in the lateral direction is positioned on the i-th column. Then, in this state, if an edge of the extraction region AR is located in midway positions of pixels as indicated by the virtual line in FIG. 7, the first parallax information obtaining unit 23 moves the extraction region AR by the least length required in the up-down direction so that it matches the edges of the pixels.

Next, in (S303), the first parallax information obtaining unit 23 calculates a similarity level between the component block selected in (S203) and the extraction region AR extracted in (S302). For example, NCC (Normalized Cross Correlation) is calculated as the similarity level. The first parallax information obtaining unit 23 adds 1 to i.

Next, in (S304), the first parallax information obtaining unit 23 determines whether i is a predetermined value. For example, the predetermined value is set to a value greater by 1 than the total number of pixels of the input image in the lateral direction. The first parallax information obtaining unit 23 proceeds to (S305) if i is the predetermined value, and returns to (S302) if i is not the predetermined value.

In (S305), out of the extraction regions AR of which similarity levels are calculated in (S303) when i shifts from the initial value to the predetermined value, an extraction region AR with the highest similarity level is regarded as a corresponding block. Then, a parallax that is a distance between the position of the corresponding block in the input image and the position of the component block in the reference image is calculated, and the process of calculating the parallax is ended.

Note that the second parallax information obtaining unit 24 obtains the second parallax information by similarly performing the process of the flowchart of FIG. 10 using the first image obtained in (S102) as the reference image and the third image obtained in (S103) as the input image. In this case, the second epipolar line EP2 extends in a horizontal direction, and thus the size of the component block is always set constant in (S202). The number of pixels of the component block in the lateral direction and the longitudinal direction is set to, for example, three pixels. The extraction region AR extracted by the second parallax information obtaining unit 24 in (S302) is positioned in the same row as the component block and its middle point in the lateral direction is the i-th column.

Thus, according to the first embodiment, the first image based on the light L1 from the subject O having passed through the first imaging lens 12 is obtained based on an output from the first solid-state image sensing element 14, and the second image based on the light L2 from the subject O having passed through the primary second lens-side light transmitting part 16c and the third image based on the light L3 from the subject O having passed through the secondary second lens-side light transmitting part 16d are obtained based on an output from the second solid-state image sensing element 17. Therefore, it is unnecessary to provide three solid-state image sensing elements in order to obtain the first image, the second image, and the third image captured from three points forming a triangular shape, and thus the three-dimensional measurement device 1 can be downsized and its cost can be reduced.

According to the first embodiment, the first lens-side light transmitting part 13c, the primary second lens-side light transmitting part 16c, and the secondary second lens-side light transmitting part 16d each have a perfect circular shape, and thus, the accuracy of the distance information obtained can be increased by a deeper depth of the field and less blurring of the image as compared to an ellipsoidal shape.

The sub-lens 18 is provided for each pixel of the second solid-state image sensing element 17 in the first direction, and thus the resolution of the second image and the third image in the first direction can be increased as compared to fewer sub-lenses 18 being provided.

### Second Embodiment

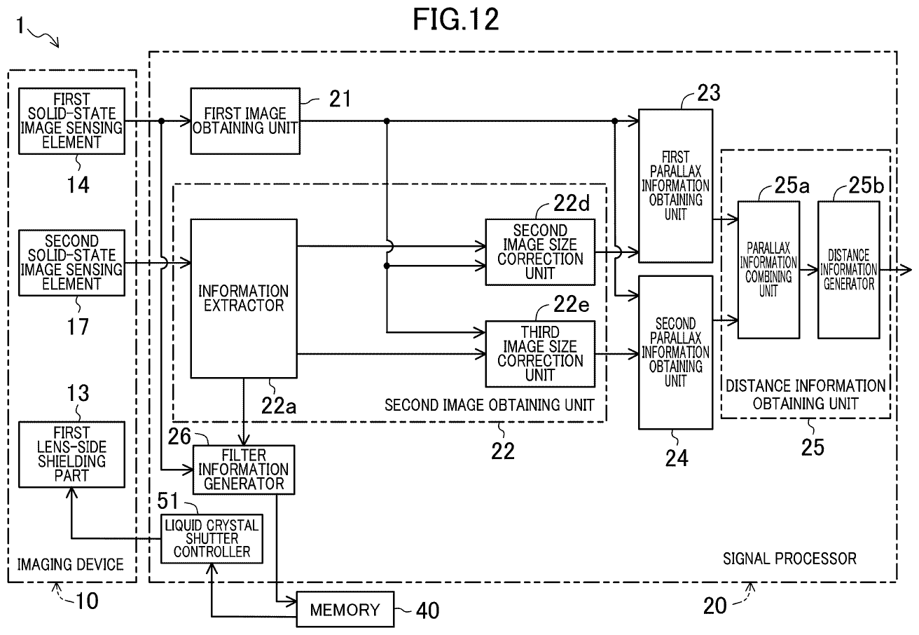

FIG. 12 shows a three-dimensional measurement device 1 of a second embodiment of the present disclosure. In the second embodiment, a first lens-side shielding part 13 consists of a liquid crystal shutter. A signal processor 20 further includes a liquid crystal shutter controller 51 as a first lens-side size adjuster. A filter information generator 26 instructs a memory 40 to store luminance values output from a first solid-state image sensing element 14 and a second solid-state image sensing element 17 in the uniform light irradiation state. Based on the luminance values output from the first solid-state image sensing element 14 and the second solid-state image sensing element 17 and stored in the memory 40, the liquid crystal shutter controller 52 adjusts the size of a first lens-side light transmitting part 13c of the first lens-side shielding part 13. For example, the liquid crystal shutter controller 51 adjusts the size of the first lens-side light transmitting part 13c of the first lens-side shielding part 13 so that an average luminance value of the pixels based on light L1 having passed through the first lens-side light transmitting part 13c in the uniform light irradiation state is equal to an average luminance value of the pixels based on light L2 and light L3 having passed through a primary second lens-side light transmitting part 16c or a secondary second lens-side light transmitting part 16d in the uniform light irradiation state. By the size of the first lens-side light transmitting part 13c being increased, the average luminance value of all the pixels output from the first solid-state image sensing element 14 can be increased. In the second embodiment, the signal processor 20 does not include a first shading correction unit 21a, a second shading correction unit 22b, and a third shading correction unit 22c. The first image obtaining unit 21 obtains, as a first image, the luminance values of a plurality of pixels output from the first solid-state image sensing element 14.

The other configurations and operations are the same as those in the first embodiment, and the same reference characters are given to the configurations identical to those of the first embodiment and detailed description thereof will thus be omitted.

### Modification of Second Embodiment

In the second embodiment, only the first lens-side shielding part 13 consists of a liquid crystal shutter, but only the second lens-side shielding part 16 may consist of a liquid crystal shutter. Then, based on the luminance values output from the first solid-state image sensing element 14 and the second solid-state image sensing element 17 and stored in the memory 40, the liquid crystal shutter controller 51 may adjust the size of at least one of the primary second lens-side light transmitting part 16c and the secondary second lens-side light transmitting part 16d of the second lens-side shielding part 16. That is, the liquid crystal shutter controller 51 may serve as a second lens-side size adjuster. Further, both the first lens-side shielding part 13 and the second lens-side shielding part 16 may consist of a liquid crystal shutter, and based on the luminance values stored in the memory 40, the liquid crystal shutter controller 51 may adjust the sizes of the first lens-side light transmitting part 13c of the first lens-side shielding part 13 and the primary second lens-side light transmitting part 16c and the secondary second lens-side light transmitting part 16d of the second lens-side shielding part 16.

In the first embodiment, the light having passed through the primary second lens-side light transmitting part 16c and the secondary second lens-side light transmitting part 16d is received at the same timing by the second solid-state image sensing element 17. However, when the second lens-side shielding part 16 consists of a liquid crystal shutter, the second image and the third image may be obtained by the second solid-state image sensing element 17 being instructed to capture an image with the second lens-side shielding part 16 being formed in only one of the primary second lens-side light transmitting part 16c and the secondary second lens-side light transmitting part 16d, and thereafter, the second solid-state image sensing element 17 being instructed to capture an image with the second lens-side shielding part 16 being formed in only the other one of the primary second lens-side light transmitting part 16c and the secondary second lens-side light transmitting part 16d.

### Third Embodiment

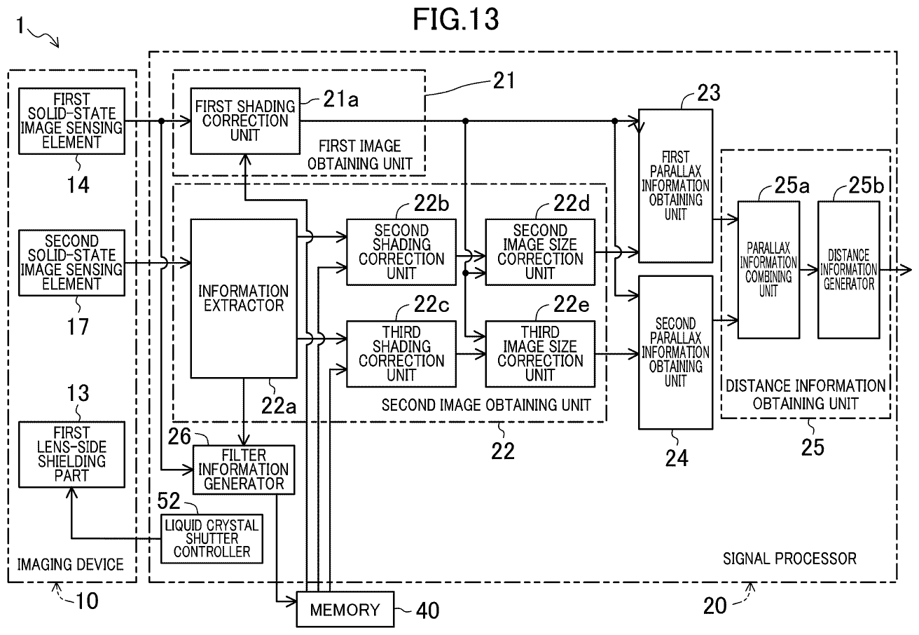

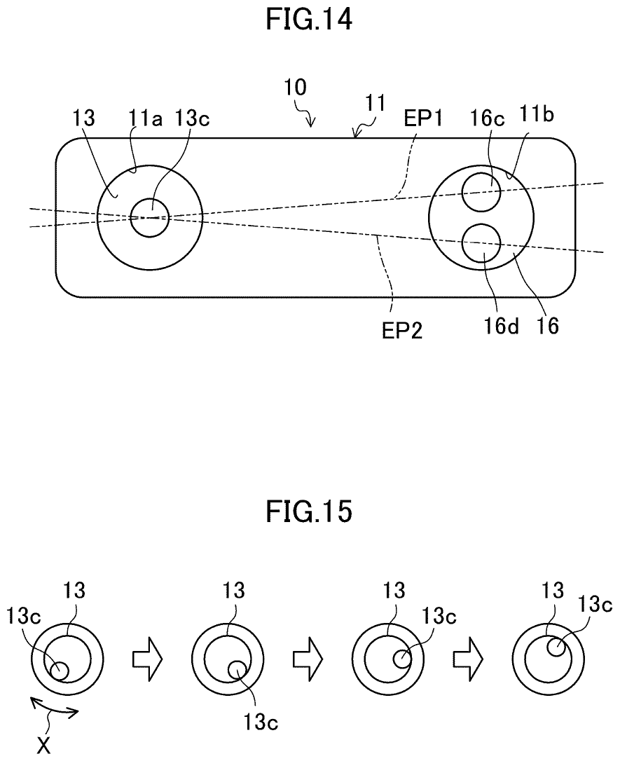

FIG. 13 shows a three-dimensional measurement device 1 of a third embodiment. In the third embodiment, a first lens-side shielding part 13 consists of a liquid crystal shutter. A signal processor 20 further includes a liquid crystal shutter controller 52 as a position adjuster that moves a first lens-side light transmitting part 13c in the second direction. The liquid crystal shutter controller 52 is capable of moving the first lens-side light transmitting part 13c to a first position shown in FIG. 2 which is the same position in the second direction (up-down direction) as that of the secondary second lens-side light transmitting part 16d and a second position shown in FIG. 14 which is a position different in the second direction (up-down direction) from those of both the primary second lens-side light transmitting part 16c and the secondary second lens-side light transmitting part 16d.

A parallax information combining unit 25a of a distance information obtaining unit 25 is further capable of generating a plurality of pieces of combined parallax information obtained through image capturing performed with the first lens-side light transmitting parts 13c being arranged in a plurality of different positions in the second direction. For example, the parallax information combining unit 25a is capable to compensate combined parallax information obtained through image capturing with the first lens-side light transmitting part 13c being arranged in the first position with combined parallax information obtained through image capturing performed with the first lens-side light transmitting part 13c being arranged in the second position.

The other configurations and operations are the same as those in the first embodiment, and the same reference characters are given to the configurations identical to those of the first embodiment and detailed description thereof will thus be omitted.

Thus, according to the third embodiment, information according to the distance between the subject O and the imaging device 10 can be more reliably obtained for all the pixels in the first image.

### Modification of Third Embodiment

In the third embodiment, the liquid crystal shutter controller 52 may move the first lens-side light transmitting part 13c in the first direction. The first lens-side shielding part 13 may consist of a glass plate 13a and the coating film 13b as in the first embodiment and have a rotation mechanism where the first lens-side shielding part 13 is rotated in the x-direction manually or automatically so that the first lens-side light transmitting part 13c is moved in the first direction and the second direction as shown in FIG. 15.

According to the modification, the first lens-side light transmitting part 13c is moved in the first direction, and thus the interval in the first direction between the first lens-side light transmitting part 13c and the primary and secondary second lens-side light transmitting part 16c and 16d can be changed and the distance resolution can be adjusted. In the following Formula 2, the distance between the subject O captured in a component block and the imaging device 10 is z, the parallax is d, the interval in the first direction between the first lens-side light transmitting part 13c and the primary and secondary second lens-side light transmitting parts 16c and 16d is b, and the focal length is f.

$$Δ z = {z}^{2} Δ d / ( fb + z Δ d ) ≃ {z}^{2} Δ d / fb \qquad ( Formula 2 )$$

From Formula 2, it can be understood that the distance resolution can be improved by lengthening the value b, i.e., the interval in the first direction between the first lens-side light transmitting part 13c and the primary and secondary second lens-side light transmitting parts 16c and 16d. The value b, i.e., the interval in the first direction between the first lens-side light transmitting part 13c and the primary and secondary second lens-side light transmitting parts 16c and 16d is set to, for example, 10 to 30 cm.

### Other Embodiments

In the first to third embodiments and their modifications, the first lens-side light transmitting part 13c, the primary second lens-side light transmitting part 16c, and the secondary second lens-side light transmitting part 16d have a perfect circular shape but may have an ellipsoidal shape.

In the first to third embodiments and their modifications, the sub-lenses 18 are arranged so that the irradiated region in the second solid-state image sensing element 17 which is irradiated with the light L2 and light L3 having passed through the sub-lenses 18 matches with one pixel in the first direction and two pixels in the second direction. However, the layout pattern of the sub-lenses 18 is not limited to that pattern. For example, the sub-lenses 18 may be arranged so that the irradiated region in the second solid-state image sensing element 17 which is irradiated with the light L2 and light L3 having passed through the sub-lenses 18 matches with two pixels in the first direction and two pixels in the second direction.

In the first to third embodiments and their modifications, the similarity level is calculated in (S303), but a difference level such as SAD (sum of absolute differences) and SSD (sum of square differences) or other evaluation values may be calculated. If the difference level is calculated in (S303), an extraction region AR with the lowest difference level may be regarded as a corresponding block in (S305).

In the first to third embodiments and their modifications, the first parallax information, the second parallax information, and the distance information are image information, but these pieces of information do not have to be image information. The first parallax information and the second parallax information may be information indicating a distance between a position of one of component parts constituting the first image and a position of its respective corresponding block in the second image or the third image. The distance information may also indicate a distance between the imaging device 10 and the subject O captured in one component part constituting the first image.

### INDUSTRIAL APPLICABILITY

The present disclosure is useful for an imaging device enabling downsizing and cost reduction of a three-dimensional measurement device, and a three-dimensional measurement device including such an imaging device.

### DESCRIPTION OF REFERENCE CHARACTERS

1 Three-Dimensional Measurement Device
10 Imaging Device
12 First Imaging Lens
13 First Lens-Side Shielding Part
13c First Lens-Side Light Transmitting Part
14 First Solid-State Image Sensing Element
15 Second Imaging Lens
16 Second Lens-Side Shielding Part
16c Primary Second Lens-Side Light Transmitting Part
16d Secondary Second Lens-Side Light Transmitting Part
17 Second Solid-State Image Sensing Element
18 Sub-Lens
21 First Image Obtaining Unit
22 Second Image Obtaining Unit
23 First Parallax Information Obtaining Unit
24 Second Parallax Information Obtaining Unit
25 Distance Information Obtaining Unit
EP1 First Epipolar Line
EP2 Second Epipolar Line
O Subject
L1, L2, L3 Light

1. An imaging device, comprising:
a first imaging lens configured to allow light from a subject to pass;
a first solid-state image sensing element configured to receive light having passed through the first imaging lens;
a second imaging lens spaced apart from the first imaging lens in a first direction and configured to allow light from the subject to pass;
a second lens-side shielding part which includes a primary second lens-side light transmitting part and a secondary second lens-side light transmitting part formed in different positions in a second direction perpendicular to the first direction, and which is configured to allow part of light from the subject toward the second imaging lens to pass using the primary second lens-side light transmitting part and the secondary second lens-side light transmitting part while blocking the rest of the light; and
a second solid-state image sensing element configured to receive light from the subject having passed through the second imaging lens.

2. The imaging device of claim 1, further comprising:
a second lens-side size adjuster configured to adjust a size of at least one of the primary second lens-side light transmitting part and the secondary second lens-side light transmitting part of the second lens-side shielding part.

3. The imaging device of claim 1, further comprising:
a first lens-side shielding part which includes a first lens-side light transmitting part, and which is configured to allow part of light from the subject toward the first imaging lens to pass using the first lens-side light transmitting part while blocking the rest of the light; and
a first lens-side size adjuster configured to adjust a size of the first lens-side light transmitting part of the first lens-side shielding part.

4. The imaging device of claim 1, further comprising:
sub-lenses interposed between the second imaging lens and the second solid-state image sensing element and positioned at a focal point of the second imaging lens.

5. The imaging device of claim 1, further comprising:
a first lens-side shielding part which includes a first lens-side light transmitting part, and which is configured to allow part of light from the subject toward the first imaging lens to pass using the first lens-side light transmitting part while blocking the rest of the light; and
a position adjuster configured to move the first lens-side light transmitting part of the first lens-side shielding part in the second direction.

6. A three-dimensional measurement device, comprising:
the imaging device of claim 1;
a first image obtaining unit configured to obtain a first image based on luminance values of a plurality of pixels output from the first solid-state image sensing element;
a second image obtaining unit configured to obtain a second image based on light having passed through the primary second lens-side light transmitting part and a third image based on light having passed through the secondary second lens-side light transmitting part, based on the luminance values of the plurality of pixels output from the second solid-state image sensing element;
a first parallax information obtaining unit configured to search for a corresponding part corresponding to at least one component part constituting the first image on an epipolar line of the second image, and obtain first parallax information indicating a distance between a position of the at least one component part in the first image and a position of the corresponding part in the second image;
a second parallax information obtaining unit configured to search for a corresponding part corresponding to at least one component part constituting the first image on an epipolar line of the third image, and obtain second parallax information indicating a distance between a position of the at least one component part in the first image and a position of the corresponding part in the third image; and
a distance information obtaining unit configured to obtain distance information indicating a distance between a subject captured in the at least one component part constituting the first image and the imaging device based on the first parallax information and the second parallax information.
